(19) United States
(12) Patent Application Publication
(10) Pub. No.: US 2024/0118901 A1
(43) Pub. Date: Apr. 11, 2024

(54) SWITCHING BETWEEN REDUNDANT AND NON-REDUNDANT MODES OF SOFTWARE EXECUTION

(71) Applicant: Xilinx, Inc., San Jose, CA (US)

(72) Inventor: Pramod Bindumadhav Bhardwaj, San Jose, CA (US)

(73) Assignee: Xilinx, Inc., San Jose, CA (US)

(21) Appl. No.: 17/962,093

(22) Filed: Oct. 7, 2022

(51) Int. Cl. G06F 9/38; G06F 9/455

(52) U.S. Cl. CPC G06F 9/3857; G06F 9/3877; G06F 9/45508

(57) ABSTRACT

Executing critical and non-critical sections of program code include executing a non-critical section of a first program by a first processor and executing a non-critical section of a second program by a second processor. The first processor signals the second processor with context to commence redundant execution of the critical section. The second processor switches from executing the second program to executing the critical section of the first program. The first processor executes the critical section of the first program concurrent with the second processor.

### TECHNICAL FIELD

The disclosure generally relates to safety-critical systems.

### BACKGROUND

Redundancy is widely used to mitigating transient and permanent faults in the components in safety-critical systems. Hardware and/or software subsystems can be implemented redundantly to achieve a desired level of resiliency. Software redundancy can involve identical code executing in lockstep on two processors. Computed results from the processors are compared at various checkpoints to confirm proper execution or detect an error.

### SUMMARY

A disclosed method includes executing a non-critical section of a first program by a first processor and executing a non-critical section of a second program by a second processor. The method incudes signaling the second processor with context of a critical section of the first program by the first processor to commence redundant execution of the critical section, and switching the second processor from executing the second program to executing the critical section of the first program in response to the signaling. The method includes executing the critical section of the first program by the first processor concurrent with the second processor executing the critical section.

Another disclosed method includes executing a non-critical section of a program by a first processor, and signaling a second processor and a third processor by the first processor to commence redundant execution of a critical section of the program. The method includes executing concurrently the critical section of the program by the second processor and the third processor.

Yet another disclosed method includes determining a non-critical section and a beginning and end of a critical section specified in source code of a program. The non-critical section is targeted for execution by a first processor, and the critical section is targeted for redundant execution by the first processor and a second processor. The method includes inserting a call to a runtime library first function before the beginning of the critical section. The first function is configured to signal the second processor by the first processor to commence redundant execution of the critical section. The method includes inserting a call to a runtime library second function for execution by the first and second processors at the end of the critical section. The second function is configured to, during execution, compare first results computed by the first processor in executing the critical section, to second results computed by the second processor in executing the critical section, and signal an error in response to the comparison indicating a mismatch between the first results and the second results. The method includes generating executable program code from the source code and calls to the first function and second function of the runtime library, and configuring a computing arrangement with the executable program code.

Other features will be recognized from consideration of the Detailed Description and Claims, which follow.

### BRIEF DESCRIPTION OF THE DRAWINGS

Various aspects and features of the methods and systems will become apparent upon review of the following detailed description and upon reference to the drawings in which:

FIG. 1 shows a flowchart of a process for redundantly executing the safety-critical sections of program code of a system, and not redundantly executing sections of code that are not safety-critical;

FIG. 2 shows a flowchart of a process for redundantly executing the safety-critical sections of program code of a system, and not redundantly executing sections of code that are not safety-critical according to another approach;

FIG. 3 shows an exemplary process for compilation of a program having critical and non-critical sections; and

FIG. 4 is a block diagram depicting an exemplary programmable system that can be configured to switch between execution of non-critical code and redundant execution of critical code.

### DETAILED DESCRIPTION

In the following description, numerous specific details are set forth to describe specific examples presented herein. It should be apparent, however, to one skilled in the art, that one or more other examples and/or variations of these examples may be practiced without all the specific details given below. In other instances, well known features have not been described in detail so as not to obscure the description of the examples herein. For ease of illustration, the same reference numerals may be used in different diagrams to refer to the same elements or additional instances of the same element.

Redundant execution of software can introduce inefficiencies in safety-critical applications. For example, software systems can include portions of code that are safety-critical and portions of code that are not safety-critical. Typical execution of an application having a portion(s) of safety-critical code and a portion(s) that is not safety-critical, involves redundantly executing the portion that is not safety-critical, even though redundant execution is not necessary. Redundantly executing portions of code that are not safety-critical unnecessarily consumes extra computing resources and can hinder system performance as a result of extra processing overhead involved in coordinating the redundant execution.

According to the disclosed approaches, in executing program code of a system that includes sections of program code that are safety-critical and sections that are not safety-critical, only the safety-critical section are executed redundantly. Sections that are not safety-critical are not executed redundantly. In executing the program code of a system that includes sections code that are safety-critical (“critical” for brevity) and sections that are not safety-critical (“non-critical” for brevity), program code of a non-critical section is executed by a first processor concurrent with a second processor being idle or executing different program code. The first processor signals the second processor to commence redundant execution of a critical section of the software system in response execution the program code indicating the beginning of a critical section. In response to the signal to commence redundant execution, the second processor switches from executing the other program to executing the critical section. The first processor and the second processor concurrently execute the critical section in lock-step. During lock-step execution, intermediate results computed by the two processors can be compared to check for possible errors. At the end of the critical section, the first processor compares its final results to the final results of the second processor, and the second processor compares its final results to the final results of the first processor. Either or both of the first and second processors can signal an error if the final results do not match.

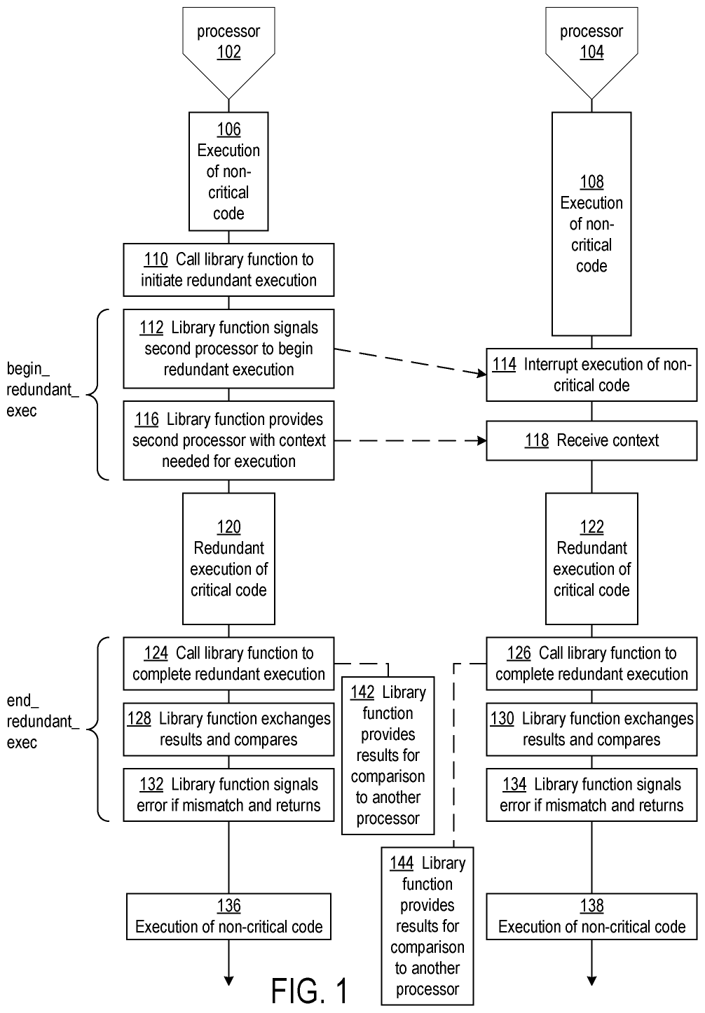

FIG. 1 shows a flowchart of a process for redundantly executing the safety-critical sections of program code of a system, and not redundantly executing sections of code that are not safety-critical. For purposes of illustration, Example 1 shows program source code that includes critical and non-critical sections. The exemplary program code performs floating point accumulation and optimizations for high-level synthesis of the program code. Only a main program portion of the code is shown, as functional details of the floating point accumulation and optimizations are not pertinent to the disclosed approaches.

```
int main(void)
{
  int x, y;
  int ret_val = 0;
  float ref_window[NUM_ELEM];
  float hls_window[NUM_ELEM];
  float threshold = ((float)1.0)/1024;
  for (x=0; x < NUM_ELEM; x++)
  {
    ref_window[x] = (65536)*PseudoCasual( );
    hls_window[x] = ref_window[x];
  }
  #PREPROCESSOR_SAFTEY_CRITICAL_START
  // REF
  float ref_res = ref_fp_accumulator(ref_window);
  // DUT
  float hls_res = hls_fp_accumulator(hls_window);
  #PREPROCESSOR_SAFTEY_CRITICAL_END
  // check results
  float total_error = 9.5367e−07f;
  float diff = ref_res − hls_res;
  if (diff < threshold) diff = 0-diff; // take absolute value
  if (diff > threshold)
  {
    total_error += (float) diff;
  }
  printf(“\n%010.4f\t%010.4f\t%010.4f\n”, ref_res, hls_res,
    total_error);
  if (total_error < 1.0)
  {
    ret_val=0;
    printf(“TEST OK! \n”);
  }
  else
  {
    ret_val=1;
    printf(“TEST FAILED!\n”);
  }
  return ret_val;
}
```

### Example 1

The critical section of code is demarcated by compiler directives. The beginning of the critical code is indicated by #PREPROCESSOR_SAFETY_CRITICAL_START, and the end of the critical code is indicated by #PREPROCESSOR_SAFETY_CRITICAL_END. The remaining code of the program is non-critical.

The flowchart of FIG. 1 shows the process flow of two processors, processor 102 and processor 104, in executing program code having a non-critical section followed by a critical section, and another (or the same) non-critical section following the critical section. The flow from top to bottom depicts time-ordered operations of the processors. The same horizontal positions on the two vertical flows do not necessarily indicate the same actual time.

Block 106 illustrates the execution of a non-critical section of code by processor 102, and block 108 illustrates the execution of a non-critical section of code of a different program by processor 104 concurrent with the block 106 by processor 102. In an alternative example, the second processor 104 can be idle while the first processor 102 is executing non-critical code.

The program having critical and non-critical sections of code can have a call to a function that initiates redundant execution of a critical section. The function can be a function in a dynamic-link library (DLL), for example. In compiling the program code of Example 1, a compiler can insert a call to the DLL function (referenced herein as, “begin_redundant_exec”) in response to the compiler directive, #PREPROCESSOR_SAFETY_CRITICAL_START. The function call can be inserted in the non-critical section that precedes the critical section. Execution of the function call is illustrated by block 110.

The begin_redundant_exec function signals the second processor 104 to begin redundant execution as illustrated by block 112 and the dashed line to block 114. The signal can be an interrupt to the second processor, for example. In response to the interrupt signal, processor 104 interrupts execution of the non-critical code at block 114 (if the processor is not idle) and waits for context from the first processor.

At block 116, execution of the begin_redundant_exec function provides context to the second processor for redundantly executing the critical section of code, as shown by the dashed line to block 118 at which the second processor 104 receives the context information. The context can include information such as address information indicating the locations of data and the critical section of code to execute, memory mapping information, and stack dependencies. According to one approach, the first and second processors could operate out of separate virtual address spaces, and the begin_redundant_exec function could map the one virtual address space to the other. According to another approach, the processors could operate on separate system-on-chips (SOCs), and the begin_redundant_exec function could copy the critical section of code from a first memory to a second memory.

The context information can be communicated to the second processor by writing the context information to a shared memory, for example. An interrupt service routine executed by the second processor can monitor the shared memory for the context information, and direct the second processor to commence execution of the critical code at block 122. After communicating the context, the begin_redundant_exec function returns and the first processor 102 commences redundant execution of the critical section as shown by block 120.

The critical section of code is redundantly executed by processors 102 and 104 as shown by blocks 120 and 122. That is, separate instances of the same program code are concurrently executed by both of processors 102 and 104. For example, in the program of Example 1 program code generated from the following source statements is redundantly executed:

float ref_res = ref_fp_accumulator(ref_window);
float hls_res = hls_fp_accumulator(hls_window);

During the redundant execution, intermediate results can be evaluated before execution of the critical section is complete.

To complete redundant execution of the critical section and before returning control to execution of a non-critical section, both the first processor 102 and second processor 104 execute a function that determines whether or not the final results computed by the critical section match. The function is referenced herein as, “end_redundant_exec,” and the compiler can insert a call to the function as the last instruction of the critical section. For example, in processing the program of Example 1, the compiler can insert a call to a DLL function in response to the compiler directive, #PREPROCESSOR_SAFETY_CRITICAL_END. The function calls performed by processors 102 and 104 are illustrated by blocks 124 and 126, respectively.

In executing the end_redundant_exec function, the processors exchange final results as shown by blocks 128 and 130 by writing to respective areas of a shared memory, for example. The end_redundant_exec function is configured with the data that indicate the addresses of the final results of both processors.

Blocks 128 and 130 also show the processors performing the comparisons of the final results. The first processor 102 compares its final results to the final results of the second processor 104, and the second processor 104 compares its final results to the final results of the first processor 102. In response to the first processor 102 determining that its final results do not match the final results of the second processor 104, the first processor signals an error as shown by block 132. In response to the second processor 104 determining that its final results do not match the final results of the first processor 102, the second processor signals an error as shown by block 134. The end_redundant_exec function can implement a timeout feature that signals an error in response to the other processor failing to communicate its final results within a prescribed period of time. An error handler (not shown) can respond to a signaled error according to application requirements.

The end_redundant_exec function executed by the first processor 102 can return control to execution of a non-critical section as shown by blocks 132 and 136. The end_redundant_exec function executed by the second processor 104 can restore context of the previously executing non-critical section and return control to execution of the non-critical section as shown by blocks 134 and 138. The second processor resumes execution of the program code that was being executed at block 108, at the instruction following the last instruction executed before the interruption.

In an alternative approach, the library functions executing on processors 102 and 104 can provide the results to one or more additional processors, logic circuits, and/or virtual machines (“processor(s)” not shown) for comparison and signaling an error as shown by blocks 142 and 144. The one or more other processors can signal an error in response to a mismatch of the results.

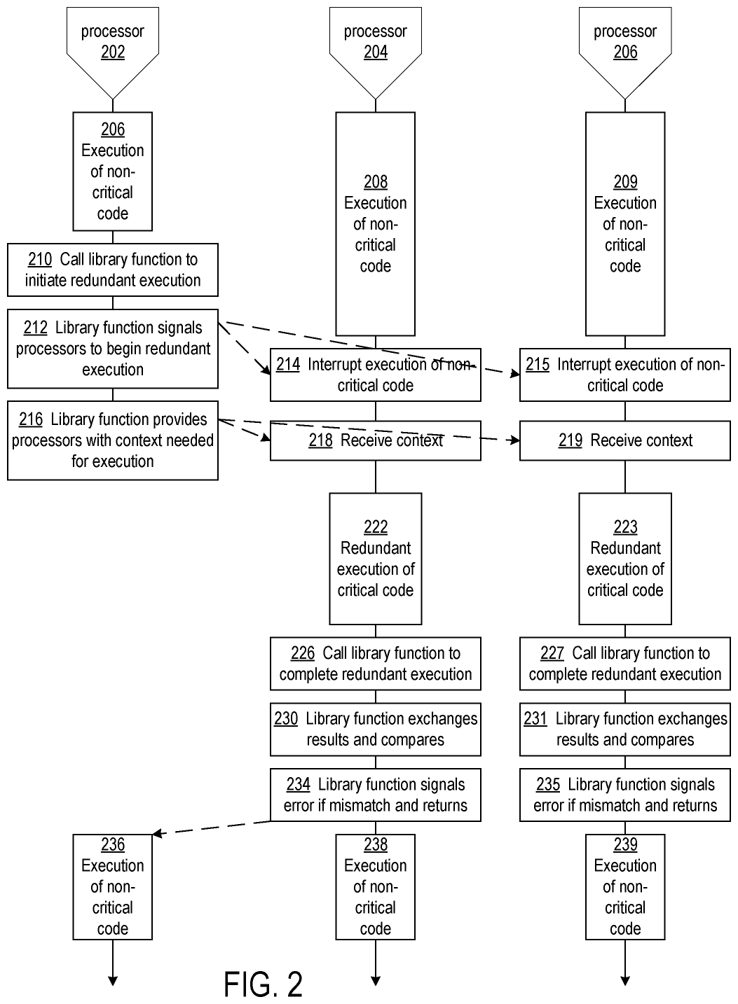

FIG. 2 shows a flowchart of a process for redundantly executing the safety-critical sections of program code of a system, and not redundantly executing sections of code that are not safety-critical according to another approach. The approach of FIG. 2 involves a system having three processors 202, 204, and 206, with one of the processors directing the other two to switch between execution non-critical sections and redundant execution of critical sections of code. Processors 202, 204, and 206 are shown as concurrently executing non-critical sections of code in blocks 206, 208, and 209, respectively. The non-critical sections of code being executed in blocks 206, 208, and 209 are sections of different programs.

Though the example of FIG. 2 (and of FIG. 1) shows two processors redundantly executing critical sections of code, it will be recognized that three or more processors can be configured to redundantly execute critical sections of code according to the disclosed methods and application requirements.

The main program having a non-critical section and a critical section is executed by processor 202, which directs processors 204 and 206 to redundantly execute the critical section when appropriate. The program having the critical section of code can have a call to a begin_redundant_exec function that signals processors 204 and 206 to commence redundant execution of the critical section. The call to the begin_redundant_exec function is shown as block 210.

The begin_redundant_exec function signals the processors 204 and 206 to begin redundant execution as illustrated by block 212 and the dashed line to blocks 214 and 215. The signals can be interrupts to the processors, for example. In response to the interrupt signal, processor 204 interrupts execution of the non-critical code at block 214 (if the processor is not idle) and waits for context from processor 202. In response to the interrupt signal, processor 206 interrupts execution of the non-critical code at block 215 (if the processor is not idle) and waits for context from processor 209.

In systems having more than two processors available for redundant execution of critical sections of code, the processor that initiates the redundant execution can monitor the utilization of each of the available processors and direct the least utilized processors to perform the redundant execution.

At block 216, execution of the begin_redundant_exec function provides context to the processors 205 and 206 for redundantly executing the critical section of code, as shown by the dashed lines to blocks 218 and 219, at which the processors 204 and 206 receive the context information. The context can include information such as address information indicating the locations of data and the critical section of code to execute, memory mapping information, and stack dependencies.

The context information can be communicated to the processors 204 and 206 by writing the context information to a shared memory, for example. A system service routine executed by the processors can monitor the shared memory for the context information, and direct the processors to redundantly execute the critical code at blocks 222 and 223. After communicating the context, the begin_redundant_exec function returns and processor 202 can wait for completion of the redundant executions.

To complete redundant execution of the critical section and before returning control to execution of a non-critical section, both of processor 202 and 204 execute an end_redundant_exec function. The function calls performed by processors 202 and 204 are illustrated by blocks 226 and 227, respectively.

In executing the end_redundant_exec function, the processors exchange final results as shown by blocks 230 and 231 by writing to respective areas of a shared memory, for example. The end_redundant_exec function is configured with the data that indicate the addresses of the final results of both processors.

Blocks 230 and 231 also show the processors performing the comparisons of the final results. The processor 204 compares its final results to the final results of processor 206, and processor 206 compares its final results to the final results of processor 204. In response to processor 204 determining that its final results do not match the final results of processor 206, processor 204 signals an error as shown by block 234. In response to processor 206 determining that its final results do not match the final results of processor 204, processor 206 signals an error as shown by block 235. The end_redundant_exec function can implement a timeout feature that signals an error in response to the other processor failing to communicate its final results within a prescribed period of time. An error handler (not shown) can respond to a signaled error according to application requirements.

In an alternative approach, the library functions executing on processors 204 and 206 can provide the results to one or more additional processors, logic circuits, and/or virtual machines (“processor(s) not shown) for comparison and signaling an error, as exemplified by blocks 142 and 144 in the approach of FIG. 1. The one or more other processors can signal an error in response to a mismatch of the results. The comparison processor can be processor 202 or another processor, logic circuit, or virtual machine.

The end_redundant_exec function executed by processor 204 can return control to execution of a non-critical section as shown by blocks 234 and 238, and the end_redundant_exec function executed by processor 206 can return control to execution of a non-critical section as shown by blocks 235 and 239. Processor 204 resumes execution of the program code that was being executed at block 208, at the instruction following the last instruction executed before the interruption, and processor 206 resumes execution of the program code that was being executed at block 209, at the instruction following the last instruction executed before the interruption. The end_redundant_exec function can also signal processor 202 to resume execution of the program having non-critical and critical sections as shown by the dashed line to block 236.

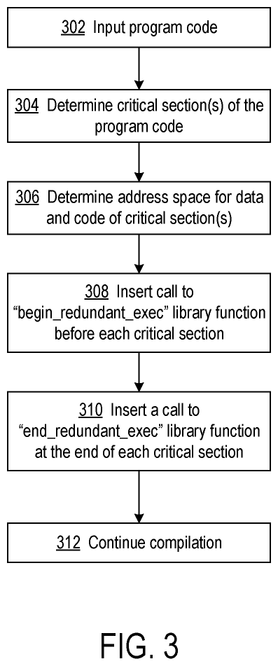

FIG. 3 shows an exemplary process for compilation of a program having critical and non-critical sections. Generally, the compilation process recognizes compiler directives and generates the executable code along with the contextual information required for redundant execution. The generated executable code is supplemented with code that supports runtime switching from executing a non-critical section of code to executing a critical section of code and switching from executing a critical section of code to executing a non-critical section of code. The code that supports the switching includes code for context switching, interrupting another processor(s), gathering results of redundant execution by the processors, comparing the results, and signaling errors as required. The contextual information includes an addressing scheme for referencing the executable code and input and output data elements, address of results from the other processor, stack dependencies, memory management unit mapping etc.

The compiler inputs the source program code at block 302. At block 304, the compiler determines the bounds (beginning and end) of each critical section of code. As indicated above, the beginning and end of a critical section can be indicated by compiler directives in the source code.

At block 306, the compiler determines the address space for executable code and data elements to be accessed by the processors in redundantly executing the critical section of code. In determining the address space, the compiler determines address information to provide to another processor(s) when redundant execution of a critical section is to commence.

The address space can vary according to application objectives. For example, the redundant processors can operate in a shared memory and a shared virtual address space. Alternatively, the processors can operate with virtual address spaces that are independent of one another. The processors can also operate with separate physical RAMs.

At block 308, the compiler inserts a call to the begin_redundant_exec function of a runtime library before the beginning of the critical section, and at block 310 the compiler inserts a call to the end_redundant_exec function at the end of the critical section.

The compiler can continue the compilation process at block 312 after identifying the critical section(s) and inserting the library function calls to begin and complete execution of the critical section(s). In continuing compilation, the compiler can generate executable program code from the source code and calls to the begin_redundant_exec and end_redundant_exec functions of the runtime library. After compilation, the executable code can be loaded and linked in memory of a computing arrangement to configure the computing arrangement into a system that can operate consistent with the functional specification of the original source code.

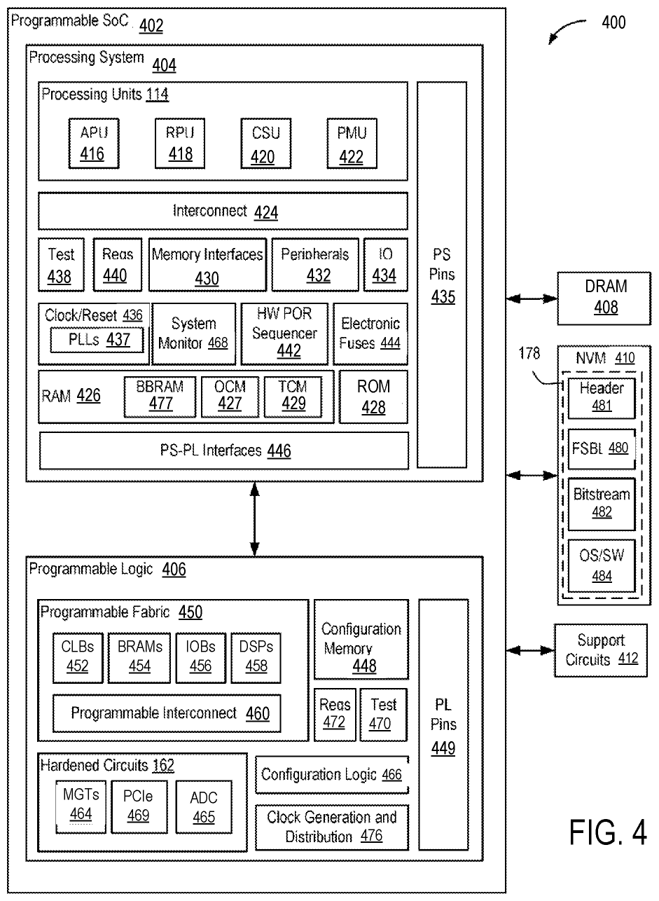

FIG. 4 is a block diagram depicting an exemplary programmable system 400 that can be configured to switch between execution of non-critical code and redundant execution of critical code. The programmable system 400 comprises a programmable system-on-chip (SoC) 402 coupled to a dynamic random access memory (DRAM) 408, a nonvolatile memory (NVM) 410, and various support circuits 412. The support circuits 412 can include oscillators, voltage supplies, and the like configured to support operation of the programmable SoC 402. The DRAM 408 can include any type of DRAM, such as synchronous DRAM (SDRAM), DDR-SDRAM, or the like. The NVM 410 can include any type of nonvolatile memory, such as any type of Flash memory, secure digital (SD) memory, or the like.

The programmable SoC 402 includes a processing system (“PS 404”) and programmable logic (“PL 406”). The PS 404 includes processing units 414, interconnect 424, RAM 426, ROM 428, memory interfaces 430, peripherals 432, input/output (IO) circuits 434, clock/reset circuits 436, test circuits 438, registers (regs) 440, a hardware (HW) power-on-reset (POR) sequencer 442, electronic fuses 444, a system monitor 468, PS-PL interfaces 446, and PS pins 435. The processing units 414 can include different types of processing units, such as an application processing unit (APU) 416, a real-time processing unit (RPU) 418, a configuration and security unit (CSU) 420, and a platform management unit (PMU) 422.

The PL 406 includes a programmable fabric 450, configuration memory 448, hardened circuits 462, registers 472, test circuits 470, electronic fuses 474, clock generation and distribution circuits 476, configuration logic 466, and PL pins 449. The programmable fabric 450 includes configurable logic blocks (CLBs) 452, block RAMs (BRAMs) 454, input/output blocks (IOBs) 456, digital signal processing blocks (DSPs) 458, and programmable interconnect 460. The hardened circuits 462 include multi-gigabit transceivers (MGTs) 464, peripheral component interface express (PCIe) circuits (“PCIe 469”), analog-to-digital converters (ADC) 465, and the like.

Referring to the PS 404, each of the processing units 414 includes one or more central processing units (CPUs) and associated circuits, such as memories, interrupt controllers, direct memory access (DMA) controllers, memory management units (MMUs), floating point units (FPUs), and the like. The interconnect 424 includes various switches, busses, communication links, and the like configured to interconnect the processing units 414, as well as interconnect the other components in the PS 404 to the processing units 414.

The RAM 426 includes one or more RAM modules, which can be distributed throughout the PS 404. For example, the RAM 426 can include battery backed RAM (BBRAM 477), on-chip memory (OCM) 427, tightly coupled memory (TCM) 429, and the like. One or more of the processing units 414 can include a RAM module of the RAM 426. Likewise, the ROM 428 includes one or more ROM modules, which can be distributed throughout the PS 404. For example, one or more of the processing units 414 can include a ROM module of the ROM 428. The registers 440 include a multiplicity of registers distributed throughout the PS 404. The registers 440 can store various settings and status information for the PS 404.

The memory interfaces 430 can include a DRAM interface for accessing the DRAM 408. The memory interfaces 430 can also include NVM interfaces for accessing the NVM 410. In general, the memory interfaces 430 can include any type of volatile memory interface (e.g., DRAM, double-date rate (DDR) DRAM, static RAM (SRAM), etc.) and any type of nonvolatile memory interface (e.g., NAND Flash, NOR flash, SD memory, etc.).

The peripherals 432 can include one or more components that provide an interface to the PS 404. The peripherals 432 can include peripheral components, as well as IO interfaces to connect to external peripheral components. For example, the peripherals 432 can include a graphics processing unit (GPU), a display interface (e.g., DisplayPort, high-definition multimedia interface (HDMI) port, etc.), universal serial bus (USB) ports, Ethernet ports, universal asynchronous transceiver (UART) ports, serial peripheral interface (SPI) ports, general purpose IO (GPIO) ports, serial advanced technology attachment (SATA) ports, PCIe ports, and the like. The peripherals 432 can be coupled to the IO circuits 434. The IO circuits 434 can include multiplexer circuits, serializer/deserializer (SERDES) circuits, MGTs, and the like configured to couple the peripherals 432 to IO pins of the PS pins 435. The IO circuits 434 can also couple one or more of the peripherals 432 internally to the PL 406.

The test circuits 438 can include boundary scan chains, internal scan chains, test access port (TAP) controllers and other Joint Test Action Group (JTAG) circuits, debug access port (DAP) controllers, logic built-in-self-test (LBIST) engines, memory BIST (MBIST) engines, built-in-self-repair (BISR) engines, scan-chain clear engines, and the like configured to test and/or initialize the PS 404. The clock/reset circuits 436 can include various oscillators, frequency synthesizers, and the like to generate clocks for use by the PS 404. For example, the clock/reset circuits 436 can include a plurality of phase-locked loops (PLLs 437). The system monitor 468 can include logic for obtaining measurements from various sensors on the programmable SoC 402 (e.g., temperature sensors, voltage sensors, and the like). HW POR sequencer 442 can include circuitry, such as hardware state machines and associated logic, configured to initialize portions of the programmable SoC 402 for operation of the PMU 422, as discussed below. The electronic fuses 444 can form a one-time programmable memory to store various settings and data for the programmable SoC 402. The PS pins 435 provide an external interface to various components of the PS 404, such as the IO circuits 434, the memory interfaces 430, the test circuits 438, and the like. The PS pins 435 also include various other pins, such as voltage supply pins, clock pins, POR pins, boot mode pins, and the like. The PS-PL interface 446 can include IO interfaces between the PL 406 and various components of the PS 404, such as the peripherals 432, the RAM 426, the processing units 414, and the like.

Referring to the PL 406, the configuration logic 466 can include circuitry for loading a configuration bitstream into the configuration memory 448. In some examples, the configuration logic 466 can receive a configuration bitstream from the PS 404 during the boot process. In other examples, the configuration logic 466 can receive the configuration bitstream from another port coupled to the PL 406 (e.g., a JTAG port that is part of the test circuits 470). The configuration memory 448 includes a plurality of SRAM cells that control the programmable features of the PL 406, such as the programmable fabric 450 and programmable features of the hardened circuits 462.

The programmable fabric 450 can be configured to implement various circuits. The programmable fabric 450 can include a large number of different programmable tiles, including the CLBs 452, the BRAMs 454, the IOBs 456, and the DSPs 458. The CLBs 452 can include configurable logic elements that can be programmed to implement user logic. The BRAMs 454 can include memory elements that can be configured to implement different memory structures. The IOBs 456 include IO circuits that can be configured to transmit and receive signals to and from the programmable fabric 450. The DSPs 458 can include DSP elements that can be configured to implement different digital processing structures. The programmable interconnect 460 can include a multiplicity of programmable interconnect elements and associated routing. The programmable interconnect 460 can be programmed to interconnect various programmable tiles to implement a circuit design.

The hardened circuits 462 include various circuits that have dedicated functions, such as the MGTs 464, the PCIe circuits 469, the ADC circuits 465, and the like. The hardened circuits 462 are manufactured as part of the IC and, unlike the programmable fabric 450, are not programmed with functionality after manufacture through the loading of a configuration bitstream. The hardened circuits 462 are generally considered to have dedicated circuit blocks and interconnects, for example, which have a particular functionality. The hardened circuits 462 can have one or more operational modes that can be set or selected according to parameter settings. The parameter settings can be realized, for example, by storing values in one or more of the registers 472. The operational modes can be set, for example, through the loading of the configuration bitstream into the configuration memory 448 or dynamically during operation of the programmable SoC 402.

The clock generation and distribution circuits 476 can include PLLs, clock buffers, and the like for generating and distributing clocks throughout the PL 406. The test circuits 470 can include boundary scan chains, internal scan chains, TAP controllers and other JTAG circuits, and the like for testing the PL 406. The registers 472 can be distributed throughout the PL 406. For example, the registers 472 can include registers for setting parameters of the hardened circuits 462. The PL pins 449 provide an external interface to various components of the PL 406, such as the IOBs 456, the MGTs 464, the PCIe circuits 469, the ADC circuits 465, the test circuits 470, and the like.

Though aspects and features may in some cases be described in individual figures, it will be appreciated that features from one figure can be combined with features of another figure even though the combination is not explicitly shown or explicitly described as a combination.

The methods and systems are thought to be applicable to a variety of safety-critical systems. Other aspects and features will be apparent to those skilled in the art from consideration of the specification. The specification and drawings are intended be considered as examples only, with a true scope of the invention being indicated by the following claims.

1. A method comprising:
executing a non-critical section of a first program by a first processor;
executing a non-critical section of a second program by a second processor;
signaling the second processor with context of a critical section of the first program by the first processor to commence redundant execution of the critical section;
switching the second processor from executing the second program to executing the critical section of the first program in response to the signaling; and
executing the critical section of the first program by the first processor concurrent with the second processor executing the critical section.

2. The method of claim 1, wherein the signaling the second processor to commence redundant execution includes generating an interrupt signal from the first processor to the second processor.

3. The method of claim 1, wherein the signaling the second processor to commence redundant execution includes communicating address information that indicates a location of executable code of the critical section.

4. The method of claim 3, wherein the signaling the second processor to commence redundant execution includes communicating address information that indicates a location of data referenced by the critical section.

5. The method of claim 1, wherein the signaling the second processor by the first processor to commence redundant execution is in response to execution of a runtime library first function initiated in the non-critical section of the first program.

6. The method of claim 1, further comprising:
comparing by the first processor, first results computed by the first processor in executing the critical section, to second results computed by the second processor in executing the critical section;
comparing the first results and the second results by the second processor;
signaling an error by the first processor in response to the comparing by the first processor indicating a mismatch between the first results and the second results; and
signaling an error by the second processor in response to the comparing by the second processor indicating a mismatch between the first results and the second results.

7. The method of claim 6, comprising:
returning to execution of the non-critical section of the first program by the first processor after the comparing by the first processor;
restoring context of execution of the non-critical section of the second program on the second processor; and
returning to execution of the non-critical section of the second program by the second processor after the restoring.

8. The method of claim 6, comprising:
initiating execution by the first processor of a runtime library second function at completion of the critical section;
initiating execution by the second processor of the runtime library second function at completion of the critical section;
wherein the runtime library second function executing on the first processor initiates the comparing and signaling by the first processor; and
wherein the runtime library second function executing on the second processor initiates the comparing and signaling by the second processor.

9. A method comprising:
executing a non-critical section of a program by a first processor;
signaling a second processor and a third processor by the first processor to commence redundant execution of a critical section of the program; and
executing concurrently the critical section of the program by the second processor and the third processor.

10. The method of claim 9, wherein the signaling the second processor and the third processor to commence redundant execution includes generating an interrupt signal from the first processor to the second and third processors.

11. The method of claim 9, wherein the signaling the second and third processors to commence redundant execution includes communicating address information that indicates a location of executable code of the critical section.

12. The method of claim 11, wherein the signaling the second and third processors to commence redundant execution includes communicating address information that indicates a location of data referenced by the critical section.

13. The method of claim 9, wherein the signaling the second and third processors by the first processor to commence redundant execution is in response to execution of a runtime library first function initiated in the non-critical section of the program.

14. The method of claim 9, further comprising:
comparing by the second processor, first results computed by the second processor in executing the critical section, to second results computed by the third processor in executing the critical section;
comparing the first results and the second results by the third processor;
signaling an error by the second processor in response to the comparing by the second processor indicating a mismatch between the first results and the second results; and
signaling an error by the third processor in response to the comparing by the third processor indicating a mismatch between the first results and the second results.

15. The method of claim 14, comprising returning to execution of the non-critical section of the program by the first processor after the comparing by the first processor and the comparing by the second processor.

16. The method of claim 14, comprising:
initiating execution by the second processor of a runtime library second function at completion of the critical section;
initiating execution by the third processor of the runtime library second function at completion of the critical section;
wherein the runtime library second function executing on the second processor initiates the comparing and signaling by the second processor; and
wherein the runtime library second function executing on the third processor initiates the comparing and signaling by the third processor.

17. The method of claim 9, further comprising:
comparing by the first processor or another processor, first results computed by the second processor in executing the critical section, to second results computed by the third processor in executing the critical section; and
signaling an error in response to the comparison indicating a mismatch between the first results and the second results.

18. A method, comprising:
determining a non-critical section and a beginning and end of a critical section specified in source code of a program, wherein the non-critical section is targeted for execution by a first processor, and the critical section is targeted for redundant execution by the first processor and a second processor;
inserting a call to a runtime library first function before the beginning of the critical section, wherein the first function is configured to signal the second processor by the first processor to commence the redundant execution of the critical section; and
inserting a call to a runtime library second function for execution by the first and second processors at the end of the critical section, wherein the second function is configured to:
compare first results computed by the first processor in executing the critical section, to second results computed by the second processor in executing the critical section, and
signal an error in response to the comparison indicating a mismatch between the first results and the second results.

19. The method of claim 18, wherein the first function is configured to communicate address information that indicates a location of executable code of the critical section in signaling the second processor to commence redundant execution.

20. The method of claim 18, further comprising:
generating executable program code from the source code and calls to the first function and second function of the runtime library; and
configuring a computing arrangement with the executable program code.
